(19) United States
(12) Patent Application Publication
(10) Pub. No.: US 2019/0236455 A1
(43) Pub. Date: Aug. 1, 2019

(54) PRE-TRAINING NEURAL NETWORKS WITH HUMAN DEMONSTRATIONS FOR DEEP REINFORCEMENT LEARNING

(71) Applicant: ROYAL BANK OF CANADA, Montreal (CA)

(72) Inventors: Matthew Edmund TAYLOR, Edmonton (CA); Gabriel Victor DE LA CRUZ, JR., Pullman, WA (US); Yunshu DU, Pullman, WA (US)

(21) Appl. No.: 16/264,625

(22) Filed: Jan. 31, 2019

Related U.S. Application Data
(60) Provisional application No. 62/624,531, filed on Jan. 31, 2018.

(51) Int. Cl. G06N 3/08; G06N 3/04; G06K 9/62

(52) U.S. Cl. CPC G06N 3/084; G06K 9/6267; G06N 3/0472

(57) ABSTRACT

Disclosed herein are a system and method for providing a machine learning architecture based on monitored demonstrations. The system may include: a non-transitory computer-readable memory storage; at least one processor configured for dynamically training a machine learning architecture for performing one or more sequential tasks, the at least one processor configured to provide: a data receiver for receiving one or more demonstrator data sets, each demonstrator data set including a data structure representing the one or more state-action pairs; a neural network of the machine learning architecture, the neural network including a group of nodes in one or more layers; and a pre-training engine configured for processing the one or more demonstrator data sets to extract one or more features, the extracted one or more features used to pre-train the neural network based on the one or more state-action pairs observed in one or more interactions with the environment.

### CROSS-REFERENCE TO RELATED APPLICATIONS

This application is a non-provisional of, and claims all benefit, including priority to, U.S. Provisional Application No. 62/624,531, filed 31 Jan. 2018, which is incorporated herein by reference in its entirety.

### FIELD

Embodiments of the present disclosure generally relates to the field of machine learning, and in more particularly, in relation to pre-training neural networks with human demonstrations for deep reinforcement learning.

### INTRODUCTION

Machine learning, in particular, reinforcement learning is a useful mechanism for adapting computational approaches to complex tasks where there are a myriad of decision points.

However, machine learning is constrained by finite computational resources and time, as machine learning models require a period of time for conducting training iterations to optimize towards one or more goals.

This challenge is prevalent where there are a large number of potential options, for example in a complex system to be modelled. The overall learning speed is impacted by the effectiveness of training iterations. Learning speed is of particular importance as learning speed impacts the overall effectiveness of the machine learning model for a given training period.

### SUMMARY

Reinforcement learning works well but requires lots of data. Obtaining the data can be expensive, and the data itself is usually fairly random. In order to train faster, a technique is proposed to leverage recorded or demonstrated performance. The performance may be performed by a human or another machine.

This involves using a data set obtained from monitoring a human trying to accomplish a specific task. Embodiments herein are proposed demonstrating example techniques, for example, a person's inputs are logged against the game state at the time of the inputs while a person is playing several video games. This log is then fed into a specially configured neural network to train it to perform the task as demonstrated by the recording and/or the human (e.g. play the particular video game demonstrated).

In accordance with an aspect, there is provided a system for providing a machine learning architecture based on monitored demonstrations, including: a non-transitory computer-readable memory storage; at least one processor configured for dynamically training a machine learning architecture for performing one or more sequential tasks based on one or more state-action pairs, the at least one processor configured to provide: a data receiver for receiving one or more demonstrator data sets, each demonstrator data set including a data structure representing the one or more state-action pairs observed in one or more interactions with the environment; a neural network of the machine learning architecture, the neural network including a group of nodes in one or more layers; and a pre-training engine configured for processing the one or more demonstrator data sets representative of the one or more state-action pairs to extract one or more features, the extracted one or more features used to pre-train the neural network based on the one or more state-action pairs observed in one or more interactions with the environment.

In accordance with another aspect, a computer-implemented method for providing a machine learning architecture based on monitored demonstrations is provided. The method may include: receiving one or more demonstrator data sets, each demonstrator data set including a data structure representing the one or more state-action pairs observed in one or more interactions with the environment; maintaining a neural network of the machine learning architecture, the neural network including a group of nodes in one or more layers; and processing the one or more demonstrator data sets representative of the one or more state-action pairs to extract one or more features, the extracted one or more features used to pre-train the neural network based on the one or more state-action pairs observed in one or more interactions with the environment.

In accordance with another aspect, the neural network may include a group of nodes interconnected by one or more connections, the group of nodes including at least a subgroup of input nodes, a subgroup of hidden nodes, and a subgroup of output nodes.

In accordance with another aspect, the neural network is trained with a softmax cross-entropy loss function.

In accordance with another aspect, the loss function is minimized using one or more selected hyperparameters.

In accordance with another aspect, the one or more selected hyperparameters include at least one of step size alpha=0.0001, stability constant ϵ=0.001, and exponential decay rates.

In accordance with another aspect, the neural network includes one or more hidden layers having three convolutional layers and one fully connected layer.

In accordance with another aspect, the neural network includes multiple heads of output layers where each class or action has a corresponding output layer.

In accordance with another aspect, each output layer is classified as a one vs all classification.

In accordance with another aspect, each training iteration during the training period includes using a uniform probability distribution to select which output layer to train.

In accordance with another aspect, in each training iteration, the at least one processor is configured to backpropagate gradients to shared hidden layers of the neural network.

In accordance with another aspect, the neural network includes hidden layers having three convolutional layers and one fully connected layer; the neural network includes multiple heads of output layers where each class or action has a corresponding output layer; each output layer becomes a one vs all classification; each training iteration during the training period includes using a uniform probability distribution to select which output layer to train; and in each training iteration, the at least one processor is configured to backpropagate gradients to shared hidden layers of the neural network.

In various further aspects, the disclosure provides corresponding systems and devices, and logic structures such as machine-executable coded instruction sets for implementing such systems, devices, and methods.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the instant disclosure.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1A is a block schematic of an example system for pre-training neural networks with recorded or monitored demonstrations for deep reinforcement learning, according to some embodiments.

FIG. 1B is an example block schematic diagram of a pre-training engine operating in conjunction with a machine learning model engine, according to some embodiments.

FIG. 1C is a composite screenshot depicting three different games that can be used for machine learning, according to some embodiments.

FIG. 2A, FIG. 2B, and FIG. 2C are graphs charting performance evaluation of baseline and pretraining using DQN, according to some embodiments. The x-axis is the training epoch where an epoch corresponds to two million steps. The y-axis is the average testing score over four trials where the shaded regions correspond to the standard deviation.

FIG. 2A illustrates reward vs. epoch for Pong, FIG. 2B illustrates reward vs. epoch for Freeway, and FIG. 2C illustrates reward vs. epoch for Beamrider.

FIG. 3 is a graph indicative of performance evaluation on the ablation studies for Pong using DQN, according to some embodiments. The results are the average testing score over four trials where the shaded regions correspond to the standard deviation.

FIG. 4A, FIG. 41, and FIG. 4C are graphs indicative of performance of baseline and pre-training using A3C, according to some embodiments. The x-axis is the number of training steps which is also the number of visited game frames among all parallel workers. The y-axis is the average testing score over four trials where the shaded regions correspond to the standard deviation.

FIG. 4A illustrates reward vs. steps for Pong, FIG. 48 illustrates reward vs. steps for Freeway, and FIG. 4C illustrates reward vs. steps for Beamrider.

FIG. 5 is a graphical mapping showing a visualization of the normalized weights on Pong's first convolutional layer using PMfA3C, according to some embodiments. The weights (filters) are from a pre-trained classification network trained for 150,000 iterations (left image), and from the final weights after 50 million training steps in A3C (right image). To better illustrate the similarity of the weights, two zoomed-in images of a particular filter from pre-trained conv1 (green box) and final conv1 (blue box) are shown.

FIG. 6 is a block schematic of an example computing device, according to some embodiments.

FIG. 7 is an example flow chart representing a process performed by the system shown in FIG. 1.

### DETAILED DESCRIPTION

Video games can be utilized as models for testing approaches for machine learning improvements. Pre-trained networks appear to learn better than when using random initialization.

Human or recorded feedback is proposed in some embodiments to learn and/or optimize a reward function. Specific approaches are described in various embodiments, where specific features, such as cross-entropy loss, are described as mechanisms to improve focus on learned features.

For example, an alternative approach may be to pre-train the network with demonstrator data sets representative of action steps (e.g. inputs) and states, but pre-training approaches that combine the large margin supervised loss and the temporal difference loss result in approaches that try to closely imitate the demonstrator. The demonstrator data sets may be obtained through observing user actions and environment, and may be obtained from monitoring a human actor or a machine performing one or more tasks.

In contrast, some described embodiments focus on the learned features rather than imitating the demonstrator, reducing an initial exploration rate and improving efficiency of the machine learning for a given training period.

Non-experts can be used, for example, to provide the human or recorded feedback. A comparative analysis is described below relating to one or more proposed approaches impacts deep reinforcement learning techniques and how well this approach can complement existing deep RL algorithms when human demonstrations (or other recorded demonstrations) are available, with a focus on learning the underlying features.

In a large neural network model, there may be millions of parameters, such as nodes and weights, that need to be tuned. Pre-training the model may help tune some of these parameters. A model engine may learn these parameters and decide to either freeze some of the weights, or not freeze any weights. The unfrozen weights may be adjustable to further train the neural network model.

In some embodiments, a pre-training engine may be utilized to update or freeze weights in a neural network model after pre-training the model. In some cases, allowing the weights to continue learning is more efficient; in other cases, such as vision recognition, freezing one or more weights may be more efficient. Demonstrator data obtained from observing demonstrations performed by a human or a machine may help with the analysis of if one or more weights should be frozen or not after the pre-training. The better the demonstrator data sets are, the more likely the weights of a neural network model can be frozen in part or in all. A pre-training engine, as described below, may help with process the demonstrator data sets and pre-train the weights of a neural network model based on features extracted from the demonstrator data sets.

A practical output of the a pre-trained neural network model is that with for the pre-trained neural network model, a reinforcement learning system (e.g. system 100) can learn things more quickly than a system with a neural network model that has not been pre-trained with demonstrator data sets. For example, if a person wants a neural network model to learn how to play a game (e.g. chess) quickly, the model can be pre-trained with demonstrator data sets obtained from observing a chess player, who may be an amateur or an expert. The model may be pre-trained with the demonstrator data sets, even if it has not previously seen any chess play movements.

Pre-training a neural network model by system embodiments described herein does not require correctly labelled data. Demonstrator data sets may be obtained from observing a human actor, who can be non-expert, performing a sequence of action steps, such as recording input keys from a human actor. The environment state may be recorded to obtain a set of (state, action) pairs.

As described in various embodiments, 1) it is not required to have a huge amount of data to gain some improvements, 2) a supervised learner can still learn important latent features even when demonstrated human data is from non-experts, and 3) the dataset is small, and may contain sub-optimal data in part.

Deep reinforcement learning (deep RL) has achieved superior performance in complex sequential tasks by using a deep neural network as its function approximator and by learning directly from raw images. A potential drawback of using raw images is that deep RL is required to learn the state feature representation from the raw images in addition to learning a policy.

As a result, deep RL can require a prohibitively large amount of training time and data to reach reasonable performance, making it difficult to use deep RL in real-world applications, especially when data is expensive.

In some embodiments, an approach is proposed to speed up training by addressing half of what deep RL is trying to solve: learning features. A proposed computer-implemented method is to learn some of the important features by pre-training deep RL network's hidden layers via supervised learning using a small set of human demonstrations.

An approach uses the raw images of the domain as network input, and a RL agent is adapted to learn the latent features while learning its policy. The approach was empirically evaluated using deep Q-network (DQN) and asynchronous advantage actor-critic (A3C) methods on the Atari 2600 games of Pong™, Freeway™, and Beamrider™.

Results show that initializing a deep RL network with a pre-trained model provides a significant improvement in training time even when pre-training from a small number of human demonstrations.

The recent resurgence of neural networks in reinforcement learning can be attributed to the widespread success of Deep Reinforcement Learning (deep RL), which uses deep neural networks for function approximation. Besides deep RL's state-of-the-art results, one of its accomplishments is its ability to learn directly from raw images. However, in order to bring the success of deep RL in virtual environments into real-world applications, a solution must address the lengthy training time that is required to learn a policy.

Deep RL suffers from poor initial performance like classic RL algorithms since it learns tabula rasa. In addition, deep RL inherently takes longer to learn because besides learning a policy it also learns directly from raw images—instead of using hand-engineered features, deep RL needs to learn to construct relevant high-level features from raw images. These problems are consequential in real-world applications with expensive data, such as those in robotics, finance, or medicine.

In order to use deep RL for solving real-world problems, there is a need to speed up its learning. One method is by using humans to provide demonstrations. However, only recently has this area gained traction as a possible way of speeding up deep RL.

Speeding up deep reinforcement learning can be achieved by addressing two problems it is trying to accomplish: 1) feature learning and 2) policy learning. Approaches described herein focus in addressing the problem of feature learning in order to speed up learning in deep RL.

The approaches include pre-training to learn the underlying features in the hidden layers of the network. Techniques are applied to speed up training in deep learning: pre-training a network. However, the success of this technique in supervised deep learning is attributed to the large datasets that are available and used to pre-train networks.

An approach is proposed in speeding up deep reinforcement learning algorithms using only a relatively small amount of non-expert human demonstrations. This approach starts by pre-training a deep neural network using human demonstrations through supervised learning. What is interesting are the underlying features are learned even with a small amount of data.

A proposed approach is tested in both Deep Q-network (DQN) and Asynchronous Advantage Actor-Critic (A3C) and evaluated its performance using Pong™, Freeway™, and Beamrider™ in the Atari 2600™ domain. Empirical results have indicated improved speed in five of the six cases. The improvement in Pong™ and Freeway™ are quite large in DQN, and A3C's improvement on Pong was especially large. The approach includes both specific use cases and broader implementations that be flexibly incorporated into multiple deep RL approaches.

A reinforcement learning RL problem is typically modeled using a Markov Decision Process, represented by a 5-tuple [symbol] S, A, P, R, [symbol] [symbol] . An RL agent explores an unknown environment by taking an action a∈A. Each action lead the agent to a certain state s∈S and a reward r˜R(s, a) is given based on the action took and the next state s′ it lands in. The goal of an RL agent is to learn to maximize the expected return value Rₜ=Σₖ₌₀^{∞}γ^{k}rₜ₊ₖ for each state at time t. The discount factor γ∈(0, 1] determines the relative importance of future and immediate rewards.

The recent development of deep RL has gained great attention due to its ability to generalize and solve problems in different domains. The first such method, deep DQN, learns to play 49 Atari games directly from screen pixels by combining Q-learning with a deep convolutional neural network. As in classic Q-learning, instead of learning the value of states, it learns the value of state-action pairs

$${Q}^{*} ( s , a ) = {𝔼}_{{s}^{′}} [ r + {max }_{{a}^{′}} {Q}^{*} ( {s}^{′} , {a}^{′} ) \vert s , a ] ,$$

which is the expected discounted reward determined by performing action a in state s and thereafter performing optimally.

The optimal policy π* can then be deduced by following actions that have the maximum Q value, Q*(s, a)=max_{π}Q^{π}(s, a).

Directly computing the Q value is not feasible when the state space is large or continuous (e.g., in Atari games).

The DQN approach uses a convolutional neural network as a function approximator to estimate the Q function Q(s, a; θ)≈Q*(s, a), where θ is the network's weight parameters. For each iteration i, DQN is trained to minimize the mean-squared error (MSE) between the Q-network and its target y=r+ [symbol] max_{a′}Q(s′, a′; θᵢ⁻), were θᵢ⁻ is the weight parameters for the target network that was generated from previous iterations.

The reward r uses reward clipping that scales the scores by clipping all rewards when positive at 1, negative at −1, and 0 when rewards are unchanged. The loss function at iteration i can be expressed as:

Lᵢ(θᵢ)= [symbol] _{s,a,r,|s′}[(y−Q(s,a;θᵢ))²]
where {s, a, r, s′} are state-action samples drawn from experience replay memory with a minibatch of size 32. The use of experience replay memory, along with a target network and reward clipping, help to stabilize learning. During training, the agent also behaves following an ϵ-greedy policy to obtain sufficient exploration of the state space.

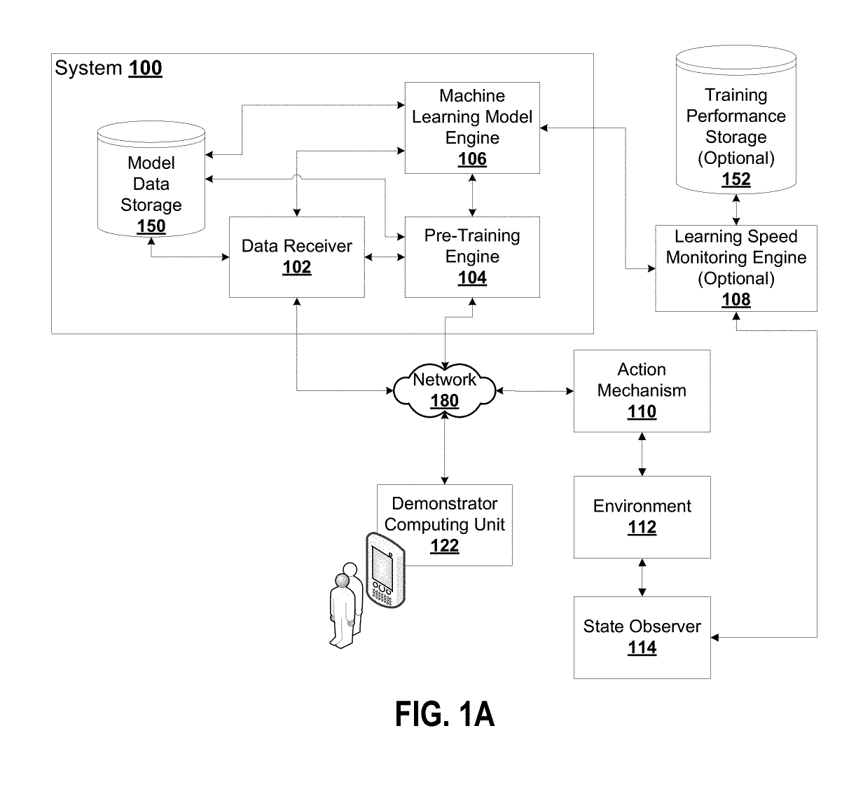

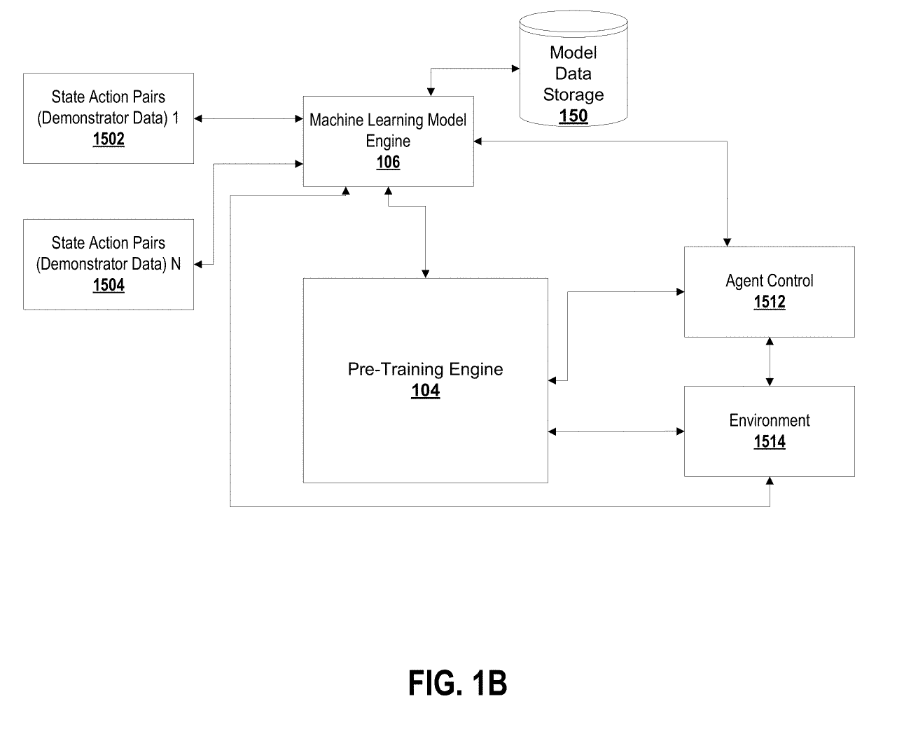

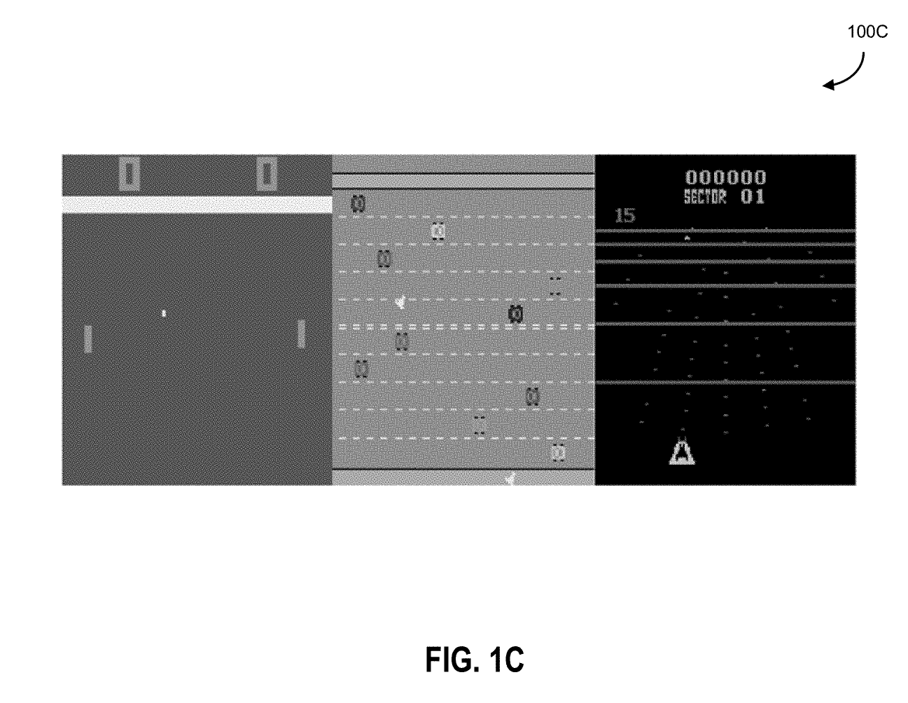

FIG. 1A is a block schematic of an example system 100 for pre-training neural networks with demonstrations for deep reinforcement learning, according to some embodiments. Various embodiments are directed to different implementations of systems described. The system 100 is adapted for augmenting machine learning with demonstrations, including at least one processor and computer readable memory. In some embodiments, the demonstrations may be performed by a human actor, who may be non-expert, or may be performed by a non-human actor, such as another machine.

System 100 may be a computer server-based system, for example, residing in a data center or a distributed resource “cloud computing” type infrastructure. System 100 may include a computer server having at least one processor and configured for dynamically maintaining a model for conducting the one or more sequential tasks and improving the model over a training period to optimize a performance variable through reinforcement learning on a model data storage 150 (e.g., a database).

In some embodiments, system 100 is adapted for augmenting machine learning with demonstrations, including at least one processor and computer readable memory. The system 100 is implemented using electronic circuits and computer components, and is adapted to pre-train the machine learning model to improve convergence or accuracy based on the demonstrator data sets.

For example, if a naive neural network is the machine learning model, and it is being used to control inputs into a video game (see e.g. screen capture 100C in FIG. 1C), the demonstrator data sets can help bias the initial training cycles of the machine learning model to, among others, avoid “foolish” moves that may be obviously inferior to the demonstrator.

Demonstrator data sets can be provided from human demonstrators, or in some embodiments, from other pre-trained machine learning models (e.g., “machines training machines”), and may include action-state observation pairs.

Demonstrator data sets can be provided in the form of encapsulated data structure elements, for example, as recorded by demonstrator computing unit 122, or observed through recorded and processed data sets of the agent associated with demonstrator computing unit 122 interacting with an environment 112, and the associated inputs indicative of the actions taken by the agent.

The states of the environment can be observed by a state observer 114, for example, by recording aspects or features of the environment. In some embodiments, the state includes image data of an interface. The states may be associated with different rewards/penalties, for example, such as a time-elapsed in a game (e.g., as extracted through optical character recognition from a time-display element), a score (e.g., as extracted through optical character recognition from a score-display element), among others.

In another example, if the agent is being used for game playing where there is a clearly defined win/loss condition, the reward may simply be provided tracked as a 1 for a win and a 0 for a loss. Where the states cannot be directly tied to specific win/loss conditions (e.g., in a board-game where the depth required to analyze victory/failure states are too distant), a proxy reward/penalty may be assigned (e.g., based on a positional evaluation or a heuristic).

A data receiver 102 is configured for receiving one or more demonstrator data sets representative of the monitored demonstrations for performing sequential tasks (e.g., playing games, trading stocks, sorting, association learning, image recognition). In some embodiments, a data receiver may be implemented in particularly configured computer hardware arrangements. In some embodiments, a data receiver may be implemented in software. In some embodiments, a data receiver may be implemented in a combination of hardware and software.

As there may be differences in quality as between demonstrators and their associated demonstrator data sets, as described in various embodiments, these potential contradictions arise in the form of differing actions that are suggested by at least one of the demonstrator data sets (e.g., from a demonstrator), or from the machine learning model itself.

In some embodiments, data receiver 102 receives demonstrator data sets from multiple demonstrator data sources.

The outputs as provided in the instruction sets may include actions to be executed that impact the environment, and for example, cause state transitions to occur. The observations may be tracked by a state observer, which may, for example, include display signal tap to record interface display aspects, among others.

A machine learning model engine 106 processes received inputs and data sets, and iterates a stored model to update the model over a period of time to generate one or more outputs, which may include instruction sets to be transmitted across network 180 to an action mechanism 110. The model may represent a neural network including a group of nodes interconnected by one or more connections, the group of nodes including at least a subgroup of input nodes, a subgroup of hidden nodes, and a subgroup of output nodes.

A feature extraction mechanism, or a feature extractor, may be provided in the form of a pre-training engine 104 configured for processing the one or more data sets representative of the monitored demonstrations to extract one or more features, the extracted one or more features used to initialize the neural network to reduce an initial exploration rate that would otherwise result in training the neural network.

The pre-training engine 104 receives demonstration data sets obtained either from logged and recorded demonstrations or extracted from monitored demonstrations conducted on a demonstrator computing unit 112. The overall performance of the machine learning engine 106 and the effectiveness of the neural network on model data storage 150 can be tracked on a learning speed monitoring engine 108, which, for example, is adapted to monitor output performance against the machine learning parameters for a given number of training iterations or time allotted for training.

In some embodiments, engine 104 is configured to provide a contradiction detection engine configured to process the one or more features by communicating the one or more features for processing by the neural network and receiving a signal output from the neural network indicative of the one or more potential contradictions.

These contradictions, for example, may be indicative of “best practices” that are contradictory. A demonstrator data set may indicate that a correct path to dodge a spike is to jump over it, while another data set may indicate that the correct path is to jump into it. Where there is contradictory actions, for example, engine 104 may generate a control signal indicating a specific action to be taken.

As described in various embodiments herein, engine 104 is configured to determine a next action based on a selection process as between an action posited by one or more demonstrators (e.g., through the demonstrator data sets), or through the machine learning model stored in model data storage 150 (e.g., a Q-learning policy).

The pre-training engine 104 is configured to associate one or more weights with one or more data elements of the one or more data sets linked to the one or more contradictions, the one or more weights modifying the processing of the one or more data elements of the one or more data sets when training the machine learning model to improve the model over the training period.

After an action is executed, machine learning engine 106 observes the outcome and associated rewards/states, and updates the machine learning model stored in model data storage 150. Accordingly, where the demonstrator data set is used as the action-source, it may, in some cases, override the machine learning model stored in model data storage 150.

In some embodiments, an optional learning speed monitoring engine 108 may be provided. Engine 108 is configured, in some embodiments to track the progress of the machine learning model in achieving rewards, tracked in an optional training performance storage 152. In an embodiment, responsive to identification that the ability of the machine learning model to obtain rewards has not improved in a number of epochs (e.g., indicating that a convergence is not occurring quickly enough or not at all), a notification is generated requesting additional demonstrator data to help the machine learning model improve.

For example, the machine learning model engine 106 may be “stuck in a rut”, and additional demonstrator data may be helpful. The machine learning model progress may be tracked through analyzing the rate of change upon which rewards are being achieved, or derivatives thereof (e.g., acceleration or higher order derivatives).

In this example, the neural network performance may be measured by how well the neural network is at performing a task (e.g., score on a game) vs. the initial exploration taken by the neural network in figuring out how to perform the task (e.g., play the game), and/or how to perform the task well (e.g., play the game with some level of aptitude). Tracked performance at different periods of time may be utilized to determine the approach taken by the neural network, and used to determine an effectiveness or a relative improvement that a demonstrator data set has (e.g., lowered initial exploration) relative to a naïve neural network.

In a more specific, non-limiting example, the neural network may be tasked with learning how to play a video game, such as Pong™.

Non-expert demonstrations may have some value as the non-expert demonstrators may still be able to provide valuable data sets that indicate some level of basics around gameplay and available moves. The feature extraction may extract out basic “principles” of gameplay from the demonstration data, to avoid exploring some paths that are clearly suboptimal that may be otherwise explored in a naïve approach. A naïve approach may, for example, have the neural network attempting pathways that are clearly not good (e.g., ball is approaching right side, test moving paddle left, which can be a bad approach since the paddle will definitely miss the ball).

If an expert demonstrator provides a data set where expert-type “moves” are shown to the neural network, it may more readily adapt these into its repertoire of moves to be explored, circumventing a need to test out different moves initially, reducing the amount of training cycles required to become proficient at the game.

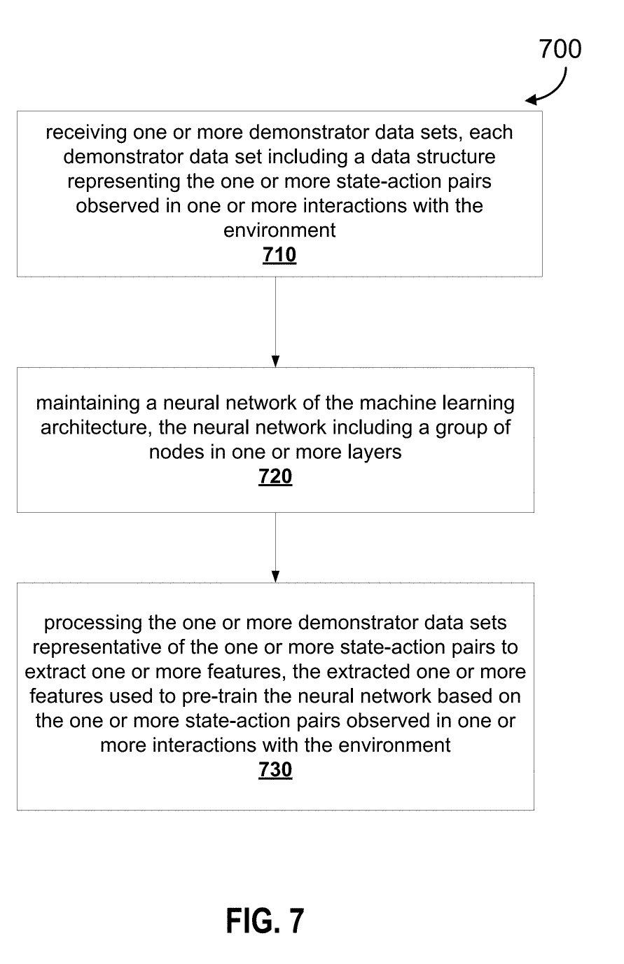

FIG. 7 is an example flow chart representing a process performed by the system shown in FIG. 1. At step 710, system 100, such as data receiver 102, may be receiving one or more demonstrator data sets, each demonstrator data set including a data structure representing the one or more state-action pairs observed in one or more interactions with the environment;

At step 720, system 100 may maintain maintaining a neural network of the machine learning architecture, the neural network may be represented by one or more data sets stored in a data storage 150. The neural network may include, in some embodiments, a group of nodes in one or more layers. In some embodiments, the group of nodes may include at least a subgroup of input nodes, a subgroup of hidden nodes, and a subgroup of output nodes. The machine learning architecture may be configured for performing one or more sequential tasks based on the one or more state-action pairs.

At step 730, system 100, such as a pre-training engine 104, may process the one or more demonstrator data sets representative of the one or more state-action pairs to extract one or more features, the extracted one or more features used to pre-train the neural network based on the one or more state-action pairs observed in one or more interactions with the environment.

FIG. 1B is an example block schematic diagram of machine learning model engine 106 operating in conjunction with a pre-training engine 104, according to some embodiments.

In this example, the demonstrator data sets 1502 and 1504 are provided to the machine learning model engine 106. In some embodiments, the machine learning model engine 106 is adapted for interoperation with the pre-training model 104 through an agent control 1512.

An agent control 1512 may provide control signals to execute actions upon environment 1514. The current state/state changes of environment 1514 are monitored and recorded and provided back to pre-training model 104 for updating the model in accordance with feedback.

In accordance with the FIG. 1B, the pre-training engine 104 can be provided separately as a retrofit to an existing machine learning model 106 to help bias and train the machine learning model as stored in model data storage 150 to achieve convergence/improve performance faster using the aid of demonstrator data sets. This is useful where a demonstrator is able to efficiently indicate to the machine learning model the correct set of actions, to reduce lost cycles that would otherwise arise from the machine learning model attempting inadvisable strategies.

### Asynchronous Advantage Actor-Critic

There are a few drawbacks of using experience replay memory in the DQN algorithm. First, having to store all experiences is space-consuming and could slow down learning. Second, using replay memory limits DQN to only off-policy algorithms such as Q-learning. The asynchronous advantage actor-critic (A3C) algorithm was proposed to overcome these problems. A3C has set a new benchmark for deep RL since it not only surpass DQN's performance in playing Atari games but also can be applied to continuous control problems.

A3C combines the actor-critic algorithm with deep learning. It differs from value-based algorithms (e.g., Q-learning) where only a value function is learned, as actor-critic is policy-based, where a policy function π(aₜ|sₜ; θ) and a value function V(sₜ; θ_{ν}) are both maintained. The policy function is called the actor, which takes actions based on the current policy π.

The value function is called the critic, which serves as a baseline to evaluate the quality of the action by returning the state value V(sₜ; θ_{ν}) for the current state under policy π. The policy is directly parameterized and improved via policy-gradient. To reduce the variance in policy gradient, an advantage function is used and determined as A(aₜ, sₜ)=Rₜ−V(sₜ; θ_{ν}) at time step t for action at aₜ state sₜ, where Rₜ is the expected return at time T. The loss function for A3C is:

L(θ)=∇₀ log π(aₜ|sₜ;θ)(Rₜ−V(sₜ;θ_{ν}))

In A3C, k actor-learners are running in parallel with their own copies of the environment and the parameters for the policy and value function. This enables the algorithm to explore different parts of the environment and observations will not be correlated.

This mimics the function of experience replay memory in DQN, while being more efficient in space and training time. Each actor-learner pair performs an update on parameters every tₘₐₓ actions, or when a terminal state is reached—this is similar to using minibatches, as is done in DQN. Updates are synchronized to a master learner that maintains a central policy and value function, which will be the final policy upon the completion of training.

### Pre-Training Network for Deep RI

Deep reinforcement learning can be divided into two sub-tasks: feature learning, and policy learning. Deep RL is successful in learning both tasks in parallel. However, learning both tasks also makes learning in deep RL very slow.

Note that learning slow refers to both data complexity and total wall-clock time. Applicants hypothesize that by addressing the feature learning task, it would allow deep RL agents to focus more on learning the policy. A proposed approach includes learning the features by pre-training deep RL's network using human demonstrations from non-experts. This approach is defined as the “pre-trained model”.

The pre-trained model method is similar to the technique of transfer in deep learning, where existing or previously trained model's parameters are used to initialize a new model to solve a different problem.

In this case, the network is pre-trained as a multi-classification problem using deep learning with human demonstrations as our training data. An assumption is that humans provide correct labels through actions demonstrated while playing the game.

The pre-trained model approach is applied in DQN and referred to as a pre-trained model for DQN (PMfDQN). In PMfDQN, a multiclass-dassification deep neural network is trained with a softmax cross entropy loss function.

The loss is minimized using Adam for optimization with the following hyperparameters: step size α=0.0001, stability constant ϵ=0.001, and using Tensorflow's default exponential decay rates β. The network architecture for the classification follows exactly the structure of the hidden layers of DQN with three convolutional layers (conv1, conv2, conv3) and one fully connected layer (fc1). In some embodiments, the hyperparameters may be chosen with grid searches.

The network's output layer also has a single output for each valid action but it uses the cross-entropy loss instead of the TD loss. The learned weights and biases from the classification model's hidden layers are used as initialization to DQN's network instead of using random initialization.

Applicants have also tested transferring all layers, including the output layer, in some experiments.

When transferring the output layer, normalization of the parameters of the output layer was necessary to achieve a positive transfer. To normalize the output layer, the system is configured to keep track of the max value of the output layer during training, which is used as a divisor to all the weights and biases during initial transfer. Without normalization, the values of the output layer tend to explode. Applicants loaded the human demonstrations in the replay memory, thus removing the need for DQN to take a uniform random action for 50,000 frames to initially populate the replay memory.

The pre-trained model method can also be applied in A3C, which Applicants will refer as pre-trained model for A3C (PMfA3C). In PMfA3C, Applicants pre-trained the multiclass-classifier using the same hyperparameters and optimization method as mentioned in PMfDQN, while experimenting with two different types of network structure. The first network uses the same hidden layers as was used with three convolutional layers (conv1, conv2, conv3) and one fully connected layer (fc1), but without the LSTM cells. And the output layer follows the exact way as described in PMfDQN. The second network is inspired from one-vs-all multiclass-classification and multitask learning.

It differs from the first network as it uses multiple heads of output layers where each class or action has its own output layer. Each individual output layer becomes a one-vs-all classification. During each training iteration it uses a uniform probability distribution to select which output layer to train, and in each iteration, gradients are backpropagated to the shared hidden layers of the network. In both multiclass networks, only the hidden layers are used to initialize A3C's network.

Since DQN uses experience replay memory, it is also possible to pre-train its network just by loading the human demonstrations in the replay memory. This experiment is referred to as pre-training in DQN (PiDQN). While being a naive way to incorporate human demonstrations in DQN, this is an interesting method to pre-train as it allows the DQN agent to learn both the features and policy without any interaction with the actual Atari environment. However, this pre-training method does not generalize to A3C and/or other deep RL algorithms that do not use a replay memory.

Additional experiments were conducted in DQN that combines PMfDQN and PiDQN, with the goal of exploring whether a combined approach would achieve a much greater performance in DQN.

### Experimental Design

Experiments were conducted in both DQN and A3C that are both implemented using Tensorflow r 1.0.

Due to limited computational resources, Applicants tested example approaches in three Atari™ games: Pong™, Freeway™, and Beamrider™, as shown in FIG. 1. The games have 6, 3, and 9 actions, respectively. Applicants used OpenAI Gym's deterministic version of the Atari 2600™ environment with an action repeat of four.

FIG. 1C is a composite screenshot 100C depicting three different games that can be used for machine learning, according to some embodiments.

TABLE 1
Summary of pre-training experiments.

| | |
|---|---|
| PiDQN | pre-train in DQN for 150,000 iterations, |
| | batch size of 32 |
| PMfDQ | initialize DQN with pre-trained model, |
| | pre-train for 150,000 iterations, |
| | batch size of 32 |
| PMfDQN + PiDQN | initialize DQN with pre-trained model |
| | and continue to pre-train in DQN |
| PMfDQN + PiDQN | low initial exploration rate |
| (∈ = 0.1) | |
| PMfDQN (random demo) | pre-train model with random demonstrations |
| PMfDQN (no fc2) | initialize with pre-trained model excluding |
| | output layer |
| PMfA3C (no fc2) | initialize A3C with pre-trained model, |
| | pre-train for 150,000 iterations, |
| | batch size 32 |
| PMfA3C (no fc2, | pre-train model using one-vs-all |
| 1-vs-all) | multi-class classification, longer |
| | pre-training |
| PMfA3C (no fc2, | pre-train model using only one out |
| 1-vs-all, 1-demo) | of the five demonstrated game play |

An network architecture and hyperparameters for DQN are adopted was done previously in a 2015 paper by Mnih et al., and an approach was used similar to that of Sharma et al., 2017 for the LSTM-variant of A3C as their work closely replicates the results of an original A3C paper (Mnih et al., 2016).

However, note that there are two key differences from the original A3C work. First, while using the same network architecture as in Mnih et al., 2015, for the three convolutional layers (conv1, conv2, and conv3), the fully connected layer (fc1) was modified to have 256 units (instead of 512) to connect with the 256 LSTM cells that followed.

Second, the proposed approach of some embodiments uses tmax=20 instead of tmax=5. 16 actor-learner threads were used for all A3C experiments. In both DQN and A3C, the four most recent game frames were used as input to the network where each frame is pre-processed. A similar evaluation technique for both DQN and A3C were taken such that the average reward over 125,000 steps was taken.

In addition, DQN is evaluated as a deterministic policy where an agent uses an ϵ-greedy action selection method, where ϵ=0.05. In A3C, it is evaluated as a stochastic policy where it uses the output policy as action probabilities.

### Collection of Human Demonstration

Applicants used OpenAI Gym's keyboard interface to allow a human demonstrator to interact with the Atari™ environment. The demonstrator is provided with game rules and a set of valid actions with their corresponding keyboard keys for each game. The action repeat was set to one to provide smoother transitions of the games during human play, whereas the action repeat is set to four during training.

During the demonstration, every fourth frame of the game play was collected, saving the game state using the game's image, action taken, reward received, and if the game's current state is a terminal state. The format of the stored data follows the exact structure of the experience replay memory used in DQN.

A non-expert human demonstrator was used where the demonstrator plays five games. Each game play has a maximum of five minutes of playing time. The demonstration ends when the game play reaches the time limit or when game terminates—whichever comes first.

Table 2 provides a breakdown of human demonstration size for each game and the human performance level.

Results from pre-training deep RL's network for DQN and A3C are described below.

### DQN

Using PMfDQN, one multiclass-classification network was trained for each Atari game with the human demonstration dataset. Each training was done using a batch size of 32 for 150,000 training iterations.

TABLE 2
Human demonstration over five plays per game.

| Game | Worst Score | Best Score | # of Frames |
|---|---|---|---|
| Beamrider ™ | 2,160 | 3,406 | 11,205 |
| Freeway ™ | 28 | 31 | 10,241 |
| Pong ™ | −10 | 5 | 11,265 |

The number of training iterations is determined to be the shortest number of iterations where the training loss for all games converge approximately to zero. The trained classification networks provide us with the pre-trained models. The pre-trained model that consists of the weights and biases are used to initialize DQN's network.

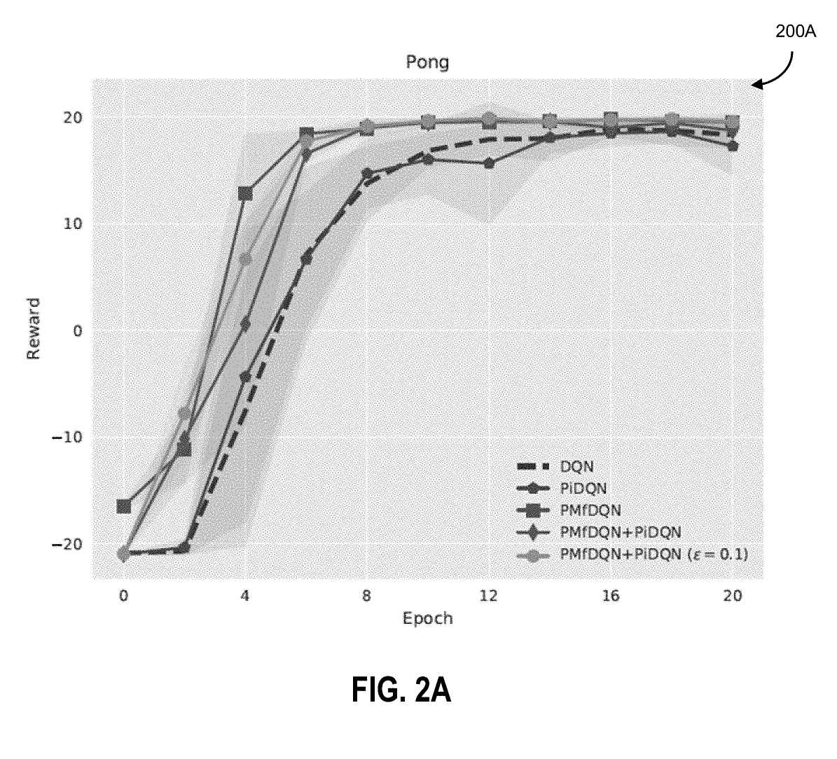

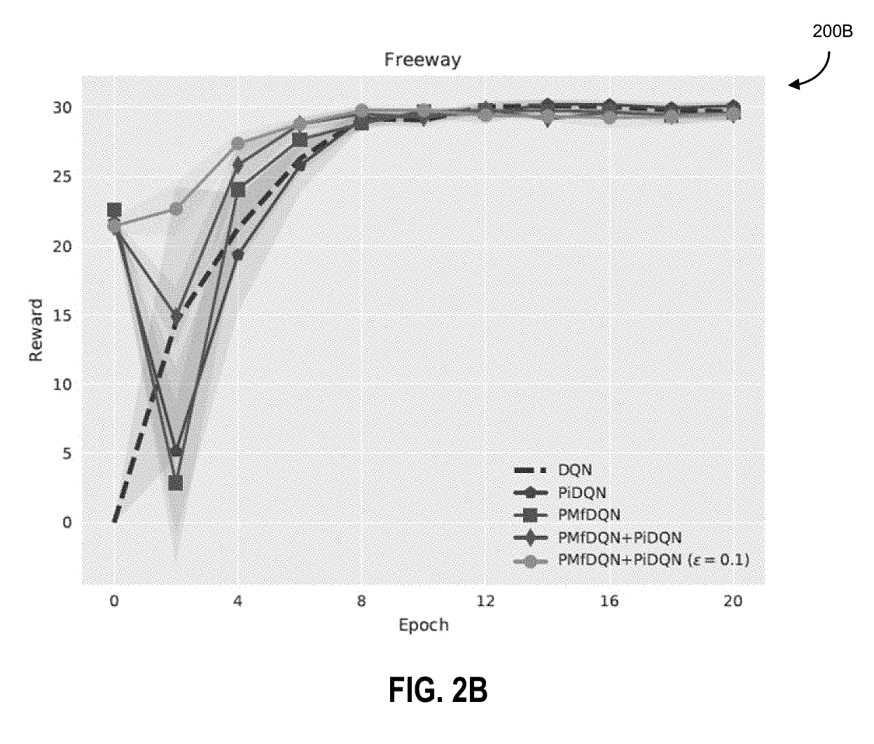

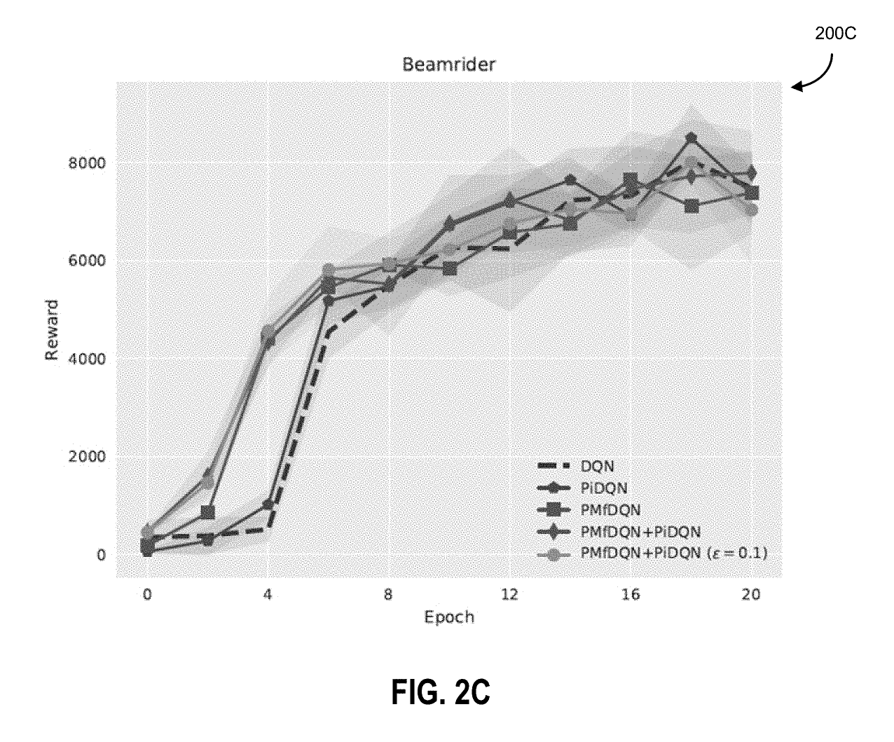

FIG. 2A, FIG. 2B, and FIG. 2C are graphs charting performance evaluation of baseline and pretraining using DQN, according to some embodiments. The x-axis is the training epoch where an epoch corresponds to two million steps. The y-axis is the average testing score over four trials where the shaded regions correspond to the standard deviation.

FIG. 2A illustrates reward vs. epoch for Pong 200A, FIG. 2B illustrates reward vs. epoch for Freeway 200B, and FIG. 2C illustrates reward vs. epoch for Beamrider 200C.

Results in FIG. 2A, FIG. 2B, and FIG. 2C shows that PMfDQN speeds up training in all three Atari™ games. Applicants also tested PiDQN with the same number of pre-training iterations as in PMfDQN. When comparing PiDQN to PMfDQN, PiDQN did not provide improvement in Freeway™ and Beamrider™ based on the average total reward, and PiDQN was even worse for Pong when compared to PMfDQN. However, PiDQN for Beamrider™ did provide some improvement with an average total reward of 5,120 compared to DQN average total reward of 4,894. This shows that in cases where pre-training cannot be done naively, that a system can utilize supervised learning for pre-training.

In addition, to see if one can further improve DQN through pre-training, PMfDQN was used, followed by PiDQN with 150,000 pre-training iterations each. The results of this experiment were surprising since, with more pre-training, Applicants expected improved results.

However, FIG. 2A, FIG. 2B, and FIG. 2C shows less improvement for Pong™ when compared to PMfDQN with similar results for Beamrider™, while improvement is only observed for Freeway™.

Applicants posit that this is due to the high initial exploration rate ϵ=1 that DQN has during training. Under this setting, the agent would be taking entirely random actions until the value of a has decayed to a much lower exploration rate.

In an alternative approach, ϵ is decayed over one million steps, resulting in the replay memory being filled with experiences of random actions—Applicants have considered that this has an adverse effect to what has already been learned from the pre-training steps.

Therefore, the system is adapted in some embodiments to initialize ϵ=0.1 when using PMfDQN followed by PiDQN. Results for all games as shown in FIG. 2 reveal that combining PMfDQN with PiDQN with a low initial exploration rate is equally as good as PMfDQN by itself and was even better for Freeway™. This result is beneficial, especially when applying DQN to real-world applications since the approach of some embodiments enables the removal of high exploration rate at the initial part of the training.

To measure improvement for each pre-training method, Applicants computed the average total reward for each trial and compared each pre-training method against the DQN baseline. In PMfDQN, although the average total reward were larger than the baseline in all three games, it was only statistically significant for Pong with a p-value of 6.54×10⁻⁵.

However, the improvements in both PMfD [symbol] N+PiD [symbol] N and PMfD [symbol] NPfDp+PiD [symbol] N (ϵ=0.1) were statistically significant in all three games as indicated through t-test with p<0.05.

### Ablation Studies

Applicant considered two modifications to PfDQN to further analyze its performance. In a first ablation study, Applicants replaced human demonstrations with random demonstrations, being interested in knowing how important it is to use human demonstrations in comparison with using a random agent.

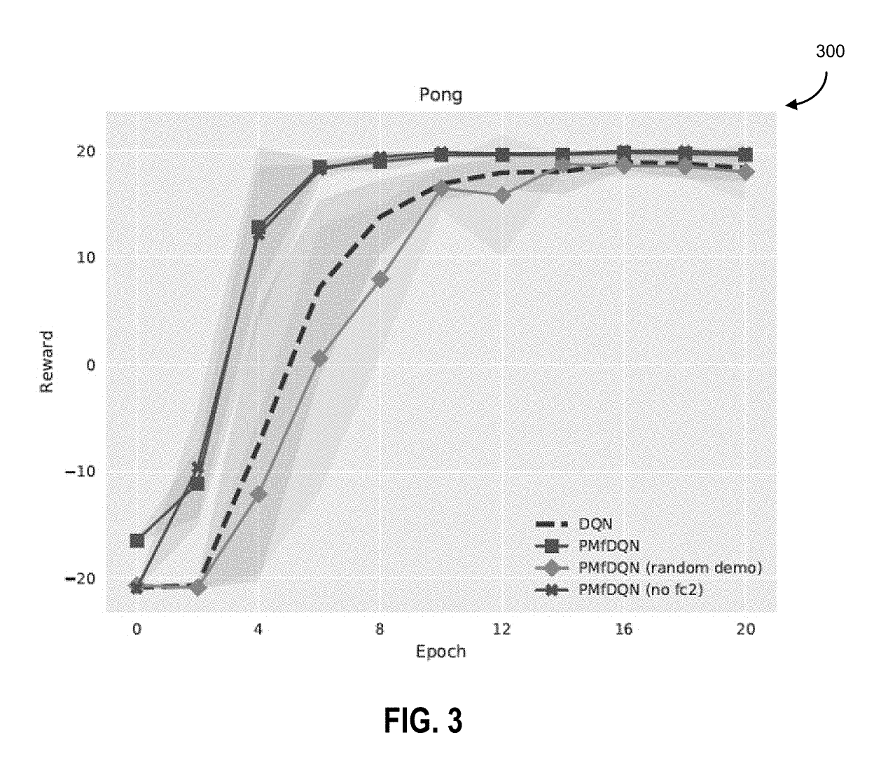

FIG. 3 is a graph 300 indicative of performance evaluation on the ablation studies for Pong using DQN, according to some embodiments. The results are the average testing score over four trials where the shaded regions correspond to the standard deviation.

Applicants conducted this experiment in Pong™ and the results in FIG. 3 show that pre-training with random demonstrations is worse than the DQN baseline. this experiment indicate that there is a need for some level of competency from the demonstrator in order to extract useful features during pre-training.

In a second ablation study, Applicants excluded the second fully connected layer (fc2) (i.e., the output layer) when initializing the DQN network with the pre-trained model. This modification allowed a determination of whether supervised learning does learn important features, particularly in the hidden layers. Applicants ran experiments without transferring the output layer from the pre-trained model.

Empirically, results in FIG. 3 show that besides losing the initial jumpstart at the beginning, the training time to reach convergence is not different from the time when using all layers. This indicates that it is actually the features in the hidden layers that provide most of the improvement in the training speed. This result may occur since the output layer of a classifier is trying to learn to predict what action to take given a state without any consideration for maximizing the reward.

Additionally, when learning from only a small amount of data where human performance was relatively poor (Table 2), the classifier's policy would be far from optimal.

### A3C

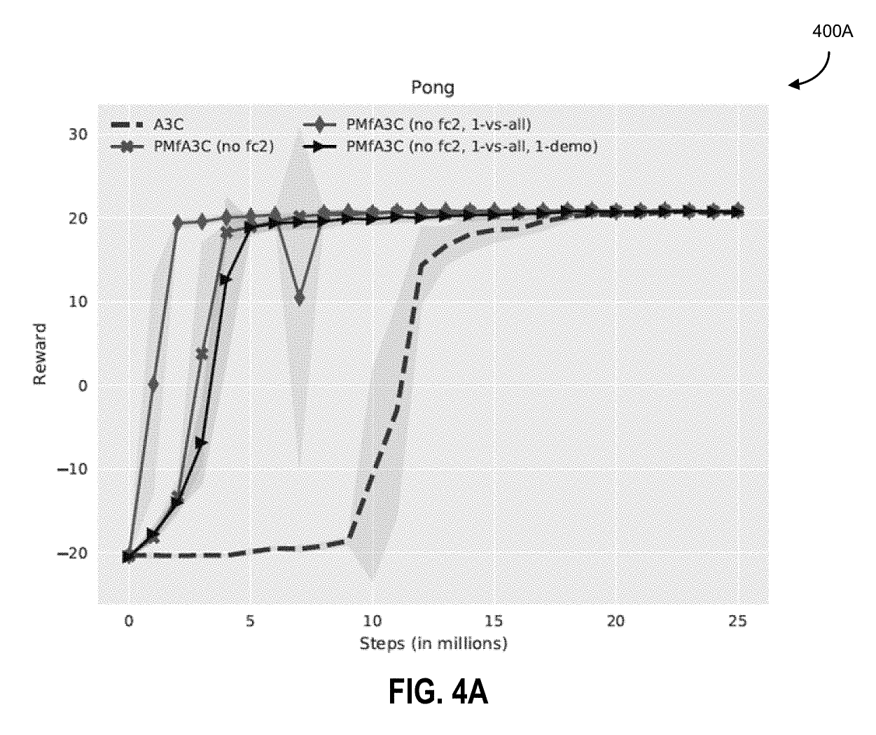

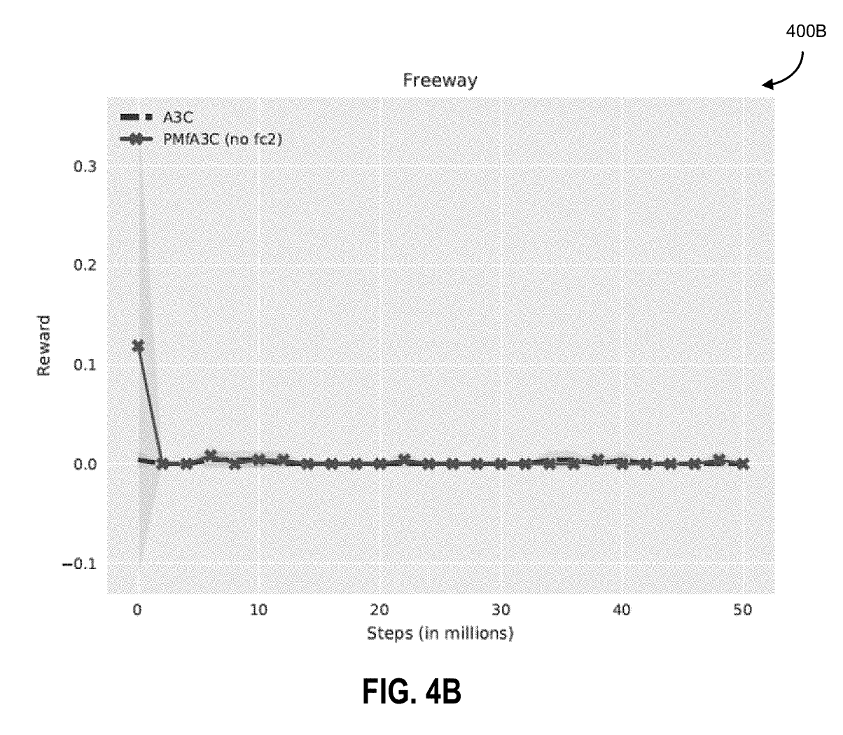

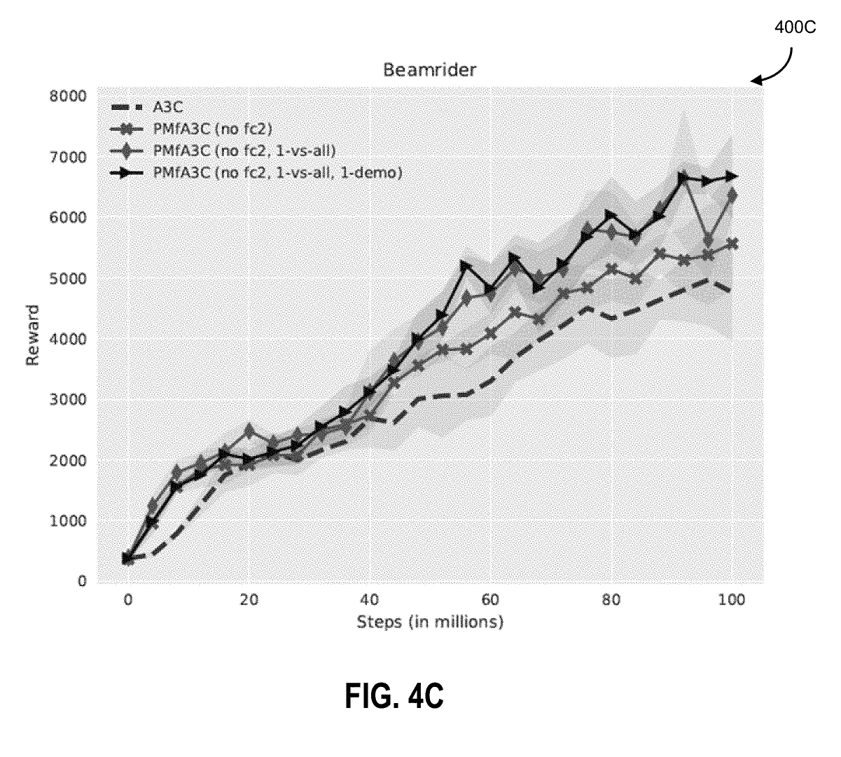

Using PMfA3C, Applicants also pre-trained multiclass-classification networks for each Atari game with human demonstrations similar to PMfDQN with a batch of 32 for 150,000 training iterations. Since the network for the LSTM-variant of A3C uses LSTM cells with two output layers, Applicants only initialize A3C's network with the pre-trained model's hidden layers. In FIG. 4, results show improvements in the training time in both Pong™ and Beamrider™, with a much higher improvement in Pong™.

FIG. 4A, FIG. 48, and FIG. 4C are graphs indicative of performance of baseline and pre-training using A3C, according to some embodiments. The x-axis is the number of training steps which is also the number of visited game frames among all parallel workers. The y-axis is the average testing score over four trials where the shaded regions correspond to the standard deviation.

FIG. 4A illustrates reward vs. steps for Pong 400A, FIG. 48 illustrates reward vs. steps for Freeway 400B, and FIG. 4C illustrates reward vs. steps for Beamrider 400C.

However, there is no improvement in Freeway™. Applicants attribute this to the poor baseline performance of Freeway™ in the original A3C work by Mnih (shown in FIG. 4 baseline). Applicants' approach focuses on learning features without addressing improvements in policy—no improvements in Freeway™ with Applicants' approach were expected. Freeway™ in A3C needs a better way of exploring states in order to learn a near-optimal policy for the game.

With strong improvements observed in A3C, Applicants posed a question of whether one still gain further improvements if one pre-trains the classification network longer.

Applicants attempted longer training using the one-vs-all multiclass-classification network with shared hidden layers. Since each class or action is trained independently, one can observe the different convergence of the training loss for each class. This allowed the use of the same technique of training until the training loss for all classes is approximately zero. Using the one-vs.-all classification, Applicants pre-trained for 450,000 iterations in Pong™ and 650,000 iterations in Beamrider™. Training longer results in a slight improvement for Beamrider™, but Pong™ shows a very large improvement, as shown in FIG. 4A, FIG. 48, and FIG. 4C.

The last experiment Applicants conducted was to test whether important features could still be learned even with a much smaller number of demonstrations, in this case, a single game play that is only five minutes of demonstration. Applicants used one-vs-all classification network to pre-train for Pong™ with only 2,253 game frames with 250,000 training iterations and similarly for Beamrider™ with 2,232 game frames with 300,000 training iterations.

In FIG. 4A, FIG. 48, and FIG. 4C, results for both Pong™ and Beamrider™ shows that improvement is still achievable with only a small amount of demonstration. It is even more remarkable in Beamrider™ how the results are as equally good as pre-training with the full set of the human demonstrations.

### Additional Analysis

In order to understand what is accomplished with pre-training, Applicants investigated the filters more closely (i.e., weights of the network layers) to determine on how much pre-trained features contribute to the final features learned.

Thus, Applicants further investigate how similar the initial weights Ŵ of a deep RL network are from its final weights W for each layer after learning a near-optimal policy. The similarity can be quantified by finding the difference between the weights using the mean squared error

$$MSE = \frac{1}{n} {\sum }_{i = 1}^{n} {( {\hat{W}}_{i} - {W}_{i} )}^{2} .$$

A layer's MSE that is smaller means higher similarity. Table 3 shows that there is a high similarity in the pre-training approach compared to random weight initialization.

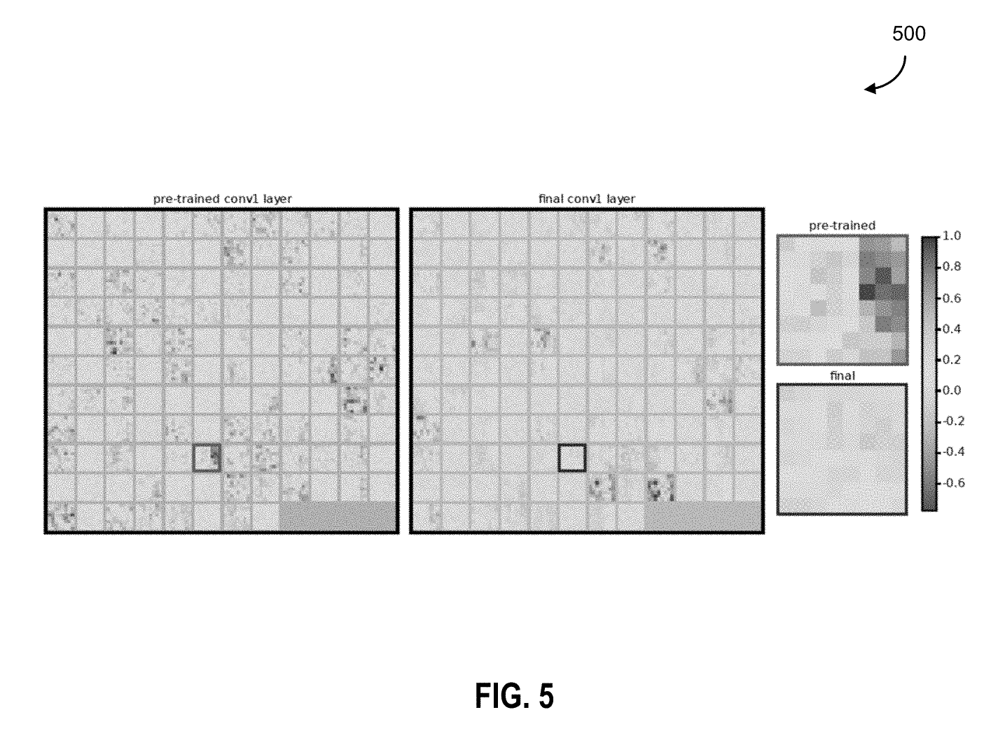

FIG. 5 is a graphical mapping 500 showing a visualization of the normalized weights on Pong's first convolutional layer using PMfA3C, according to some embodiments. The weights (filters) are from a pre-trained classification network trained for 150,000 iterations (left image), and from the final weights after 50 million training steps in A3C (right image). To better illustrate the similarity of the weights, two zoomed-in images of a particular filter from pre-trained conv1 (green box) and final conv1 (blue box) are shown.

TABLE 3
Evaluation on the similarity of features for each hidden
layer. The mean squared error (MSE) is computed between
the weights from a randomly initialized A3C network (baseline)
and the final weights. Similarly, when using a pre-trained
model as the initial weights.

| | MSE (Pong) | | MSE (Beamrider) | |
|---|---|---|---|---|
| Layer | Baseline | Pre-train | Baseline | Pre-train |
| conv1 | 1.03 × 10⁻² | 3.94 × 10⁻³ | 3.32 × 10⁻² | 2.53 × 10⁻² |
| conv2 | 8.02 × 10⁻³ | 8.00 × 10⁻⁴ | 8.50 × 10⁻³ | 4.35 × 10⁻³ |
| conv3 | 7.13 × 10⁻³ | 3.26 × 10⁻⁴ | 7.11 × 10⁻³ | 2.39 × 10⁻³ |
| fc1 | 9.57 × 10⁻⁴ | 7.54 × 10⁻⁵ | 1.07 × 10⁻³ | 3.29 × 10⁻⁴ |

Furthermore, Applicants looked at the visualization of each hidden layer and observed that the weights learned from classification and used as initial values in deep RL's network provided features that were retained even after training in deep RL. FIG. 5 shows a visualization of the first convolutional layer. The high similarity of the weights observed in all layers suggests that pre-training in classification was able to learn important features that were useful in deep RL.

The pre-training approach worked very well in Pong™. This success can be explained by the human demonstration data the classifier was pre-trained with, and the simplicity of Pong's™ game. Pong's™ states are highly repetitive when compared to the other game environments that are more dynamic. Beamrider™ has the most complex environment among all three games because it has different levels with varying difficulty. Although Freeway's™ game state is also repetitive, A3C's inability to learn a good policy is a problem that leans more towards policy learning, which is not addressed in some of the described approaches.

Human demonstrations are an important factor in the success of the approaches of some embodiments. It is important to understand how the demonstrator's performance and the amount of demonstration data affect the benefits of pre-training the network in future work.

Another issue that needs to be addressed in regards to the human demonstrations is that they suffer from highly imbalanced classes (actions). This is attributed to: 1) sparsity of some actions like the torpedo action in Beamrider™ that is limited to three uses at each level, 2) actions that are closely related like in Beamrider™ where there is a left and right action plus combined actions of left-fire and right-fire—a demonstrator would usually just use the native actions of left and right action alone and use the fire action by itself, and 3) games having a default no-operation action.

In an example, when the imbalance problem is not addressed, the classifier will learn a policy that tends to bias towards the majority classes. It is interesting that the classifier is still able to learn important features without handling this issue. However, it is observed as an interesting future work of handling the class imbalance so one would determine if it ends up learning better features and if further improvements can be observed in an approach.

There may be a limit to how much improvement pre-training can provide without addressing policy learning. In an approach, Applicants have trained a model with a policy that tries to imitate the human demonstrator, and may extend this work by using the pre-trained model's policy to provide advice to the agent.

Overall, learning directly from raw images through deep neural networks is a major factor why learning is slow in deep RL. Applicants have demonstrated that a method of initializing deep RL's network with a pre-trained model can significantly speed up learning in deep RL.

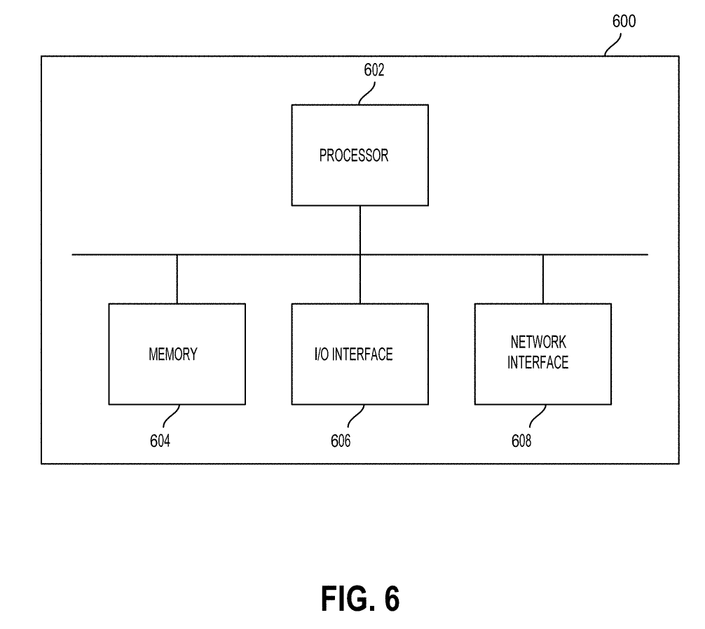

FIG. 6 is a block schematic diagram of an example computing device, according to some embodiments. There is provided a schematic diagram of computing device 600, exemplary of an embodiment. As depicted, computing device 600 includes at least one processor 602, memory 604, at least one I/O interface 606, and at least one network interface 608. The computing device 600 is configured as a machine learning server adapted to dynamically maintain one or more neural networks.

Each processor 602 may be a microprocessor or microcontroller, a digital signal processing (DSP) processor, an integrated circuit, a field programmable gate array (FPGA), a reconfigurable processor, a programmable read-only memory (PROM), or combinations thereof.

Memory 604 may include a computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM).

Each I/O interface 606 enables computing device 600 to interconnect with one or more input devices, such as a keyboard, mouse, camera, touch screen and a microphone, or with one or more output devices such as a display screen and a speaker.

Embodiments of methods, systems, and apparatus are described through reference to the drawings.

The disclosure herein provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

Although the embodiments have been described in detail, it should be understood that various changes, substitutions and alterations can be made herein.

Moreover, the scope of the present application is not intended to be limited to the particular embodiments of the process, machine, manufacture, composition of matter, means, methods and steps described in the specification.

As can be understood, the examples described above and illustrated are intended to be exemplary only.

What is claimed is:

1. A system for providing a machine learning architecture based on monitored demonstrations, the system comprising:
a non-transitory computer-readable memory storage;
at least one processor configured for dynamically training a machine learning architecture for performing one or more sequential tasks based on one or more state-action pairs, the at least one processor configured to provide:
a data receiver for receiving one or more demonstrator data sets, each demonstrator data set including a data structure representing the one or more state-action pairs observed in one or more interactions with the environment;
a neural network of the machine learning architecture, the neural network including a group of nodes in one or more layers; and
a pre-training engine configured for processing the one or more demonstrator data sets representative of the one or more state-action pairs to extract one or more features, the extracted one or more features used to pre-train the neural network based on the one or more state-action pairs observed in one or more interactions with the environment.

2. The system of claim 1, wherein the neural network is trained with a softmax cross-entropy loss function.

3. The system of claim 2, wherein the loss function is minimized using one or more selected hyperparameters.

4. The system of claim 3, wherein the one or more selected hyperparameters include at least one of step size alpha=0.0001, stability constant ϵ=0.001, and exponential decay rates.

5. The system of claim 3, wherein the neural network includes one or more hidden layers having three convolutional layers and one fully connected layer.

6. The system of claim 3, wherein the neural network includes multiple heads of output layers where each class or action has a corresponding output layer.

7. The system of claim 6, wherein each output layer is classified as a one vs all classification.

8. The system of claim 7, wherein each training iteration during the training period uses a uniform probability distribution to select which output layer to train.

9. The system of claim 8, wherein in each training iteration, the at least one processor is configured to backpropagate gradients to shared hidden layers of the neural network.

10. The system of claim 3, wherein:
the neural network includes hidden layers having three convolutional layers and one fully connected layer;
the neural network includes multiple heads of output layers where each class or action has a corresponding output layer;
each output layer is classified as a one vs all classification;
each training iteration during the training period includes using a uniform probability distribution to select which output layer to train; and
in each training iteration, the at least one processor is configured to backpropagate gradients to shared hidden layers of the neural network.

11. A computer-implemented method for providing a machine learning architecture based on monitored demonstrations, the method comprising:
receiving one or more demonstrator data sets, each demonstrator data set including a data structure representing the one or more state-action pairs observed in one or more interactions with the environment;
maintaining a neural network of the machine learning architecture, the neural network including a group of nodes in one or more layers; and
processing the one or more demonstrator data sets representative of the one or more state-action pairs to extract one or more features, the extracted one or more features used to pre-train the neural network based on the one or more state-action pairs observed in one or more interactions with the environment.

12. The method of claim 11, wherein the neural network is trained with a softmax cross-entropy loss function.

13. The method of claim 12, wherein the loss function is minimized using one or more selected hyperparameters.

14. The method of claim 13, wherein the one or more selected hyperparameters include at least one of step size alpha=0.0001, stability constant ϵ=0.001, and exponential decay rates.

15. The method of claim 13, wherein the neural network includes one or more hidden layers having three convolutional layers and one fully connected layer.

16. The method of claim 13, wherein the neural network includes multiple heads of output layers where each class or action has a corresponding output layer.

17. The method of claim 16, wherein each output layer is classified as a one vs all classification.

18. The method of claim 17, wherein each training iteration during the training period includes using a uniform probability distribution to select which output layer to train.

19. The method of claim 18, wherein in each training iteration, the at least one processor is configured to backpropagate gradients to shared hidden layers of the neural network.

20. The method of claim 13, wherein:
the neural network includes hidden layers having three convolutional layers and one fully connected layer;
the neural network includes multiple heads of output layers where each class or action has a corresponding output layer;
each output layer is classified as a one vs all classification;
each training iteration during the training period uses a uniform probability distribution to select which output layer to train; and
in each training iteration, the at least one processor is configured to backpropagate gradients to shared hidden layers of the neural network.

21. A computer readable non-transitory medium storing machine readable instructions, which when executed by a processor, cause the processor to perform:
receiving one or more demonstrator data sets, each demonstrator data set including a data structure representing the one or more state-action pairs observed in one or more interactions with the environment;
maintaining a neural network of the machine learning architecture, the neural network including a group of nodes in one or more layers; and
processing the one or more demonstrator data sets representative of the one or more state-action pairs to extract one or more features, the extracted one or more features used to pre-train the neural network based on the one or more state-action pairs observed in one or more interactions with the environment.
